(19) United States
(12) Patent Application Publication
(10) Pub. No.: US 2024/0300037 A1
(43) Pub. Date: Sep. 12, 2024

(54) METHOD FOR MACHINING SHEET-LIKE WORKPIECES, AND MACHINING DEVICE

(71) Applicant: HOMAG GMBH, Schopfloch (DE)

(72) Inventor: Franz SCHNEIDER, Villingendorf (DE)

(21) Appl. No.: 18/276,428

(22) PCT Filed: Feb. 8, 2022
(86) PCT No.: PCT/EP2022/052962

§ 371 Date: Aug. 8, 2023

(30) Foreign Application Priority Data
Feb. 9, 2021 (DE) 10 2021 102 981.3

(51) Int. Cl. B23C 3/13

(52) U.S. Cl. CPC B23C 3/13; B23C 2226/27; B23C 2226/61

(57) ABSTRACT

The invention relates to a method for machining plate-shaped workpieces (11), which are preferably made at least in part of wood, wood material, plastic, composite material or the like, by a machining device (10), the method comprising: positioning a plate-shaped workpiece (11) on a workpiece support (14), introducing at least one separating region (17) into the plate-shaped workpiece (11), positioning a machining tool (13) within the at least one separating region (17), performing a pivoting movement of the machining tool (13) in the direction of at least one narrow surface (18) of the plate-shaped workpiece (11), which is adjacent to the at least one separating region (17), wherein, as a result of the pivoting movement of the milling tool (13), a cutout (22) is introduced into the at least one narrow surface (18) of the plate-shaped workpiece (11), as well as a machining device (10) for machining plate-shaped workpieces (11).

### TECHNICAL FIELD

The invention relates to a method for machining plate-shaped workpieces as well as a machining device for machining plate-shaped workpieces.

### PRIOR ART

DE 10 2012 110 453 B4 discloses a machining device for machining plate-shaped workpieces, by means of which a large-sized initial workpiece is divided into a plurality of smaller partial workpieces. Before dividing the initial workpiece, horizontal machining of the initial workpiece is provided, during which horizontal bores are introduced into subsequent narrow surfaces of the partial workpieces. For this purpose, cutouts are introduced into the initial workpiece, which are adjacent to the subsequent narrow surfaces of the partial workpieces, so that a drilling unit can be inserted into said cutouts and the horizontal drilling process can be performed. After dividing into the partial workpieces, the regions of the initial workpiece with the cutouts are disposed of as offcuts. The dimensions of the drilling unit or the drilling tool depend on the drilling depth, and therefore in particular for greater drilling depths the cutouts must have corresponding dimensions in order to be able to insert the drilling unit thereinto. For this reason, the offcuts of the initial workpiece increase depending on the drilling depth. Moreover, due to the introduction of the additional cutouts, an increased number of work steps is necessary.

### DESCRIPTION OF THE INVENTION

The invention is based on the object of proposing a method by means of which effective machining of plate-shaped workpieces is made possible. Furthermore, it is the object of the invention to propose a machining device by means of which a reduction of workpiece offcuts as well as a reduction of work steps are achieved.

A method for machining plate-shaped workpieces is defined in claim 1. A machining device is defined in claim 11. Dependent claims relate to specific embodiments.

The object is solved by a method for machining plate-shaped workpieces, which are preferably made at least in part of wood, wood material, plastic, composite material or the like, by a machining device, the method comprising: positioning a plate-shaped workpiece on a workpiece support, introducing at least one separating region into the plate-shaped workpiece, positioning a machining tool, in particular a milling tool, within the at least one separating region, performing a pivoting movement of the machining tool in the direction of at least one narrow surface of the plate-shaped workpiece, which is adjacent to the at least one separating region, wherein, as a result of the pivoting movement of the machining tool, a cutout, in particular a groove, is introduced, in particular milled, into the at least one narrow surface of the plate-shaped workpiece.

By means of such a machining method, machining can be performed on the at least one narrow surface of the workpiece, which is adjacent to the separating region. For example, the introduction of the cutout after dividing the plate-shaped workpiece into a plurality of partial workpieces can be performed while they are clamped on a workpiece holder, whereby a reduction of the work steps for forming such a cutout can be achieved. By having the machining unit for introducing the cutout perform the pivoting movement within the separating region, a particularly narrow separating region can be provided, whereby workpiece offcuts can be reduced.

A preferred further development of the method can provide that the machining tool is positioned in the separating region at a starting position in which a rotational axis of the machining tool is aligned essentially in the direction of a longitudinal extension of the separating region.

In this way, the machining tool can have any machining tool length which can be longer than a width of the separating region. In this way, a cutout can be introduced into the narrow surface of the workpiece, which can have a greater (groove) depth than a width of the separating region.

In a further preferred embodiment of the method, the pivoting movement of the machining tool for introducing the cutout can be performed in a pivoting plane lying within the workpiece, preferably aligned parallel to a workpiece plane of the workpiece.

In this way, the cutout can be introduced into the narrow surface of the workpiece by a corresponding alignment of the machining tool at any angle. Due to the parallel alignment of the pivoting movement, the cutout can be formed in particular parallel to a workpiece surface, wherein it can be preferably provided that it is aligned centrally within the workpiece.

In an advantageous further development of the method, it can moreover be provided that the pivoting movement of the machining tool is performed about a pivot axis which is preferably aligned orthogonally to the workpiece plane of the partial workpiece.

Due to a defined inclination of the pivot axis to the workpiece plane, an angle of the cutout to the workpiece plane can be adjusted accordingly. Since the pivot axis is aligned orthogonally to the workpiece plane, in particular a precise control of the pivoting movement in the pivoting plane parallel to the workpiece plane can be made possible. In this way, exact introduction of the cutout into the narrow surface can be ensured.

In a preferred embodiment of the method, as a result of the pivoting movement of the machining tool, a partially circular cutout can be introduced into the narrow surface of the workpiece and, after the introduction of the cutout, the machining tool can be pivoted into an end position in the separating region or be pivoted back into the starting position.

In this way, a partially circular cutout, preferably an essentially semi-circular cutout, can be introduced into the narrow surface of the partial workpiece.

In a further development of the method, it can moreover be provided that, during the pivoting movement of the machining tool, a relative movement between the machining tool and the workpiece is performed along the narrow surface or the pivoting movement is interrupted for performing the relative movement.

Since the relative movement is performed between the machining tool and the workpiece, a length of the cutout can be individually adjusted.

In an alternative embodiment of the method, it can moreover be provided that the machining tool is pivoted, after positioning within the at least one separating region, into an intermediate position, whereby a partial groove is introduced into the narrow surface, and at least one relative movement in at least one spatial direction is brought about between the machining tool and the workpiece in order to form a cutout with an individual shape.

The machining tool is provided to be movable preferably in two spatial directions, particularly preferably in three spatial directions, with respect to the narrow surface of the workpiece. In this way, a cutout of any length, width, depth and/or shape can be introduced into the narrow surface. Such a shape can, for example, be a rectangular cutout, a serrated cutout, a corrugated cutout, a round cutout, an oval cutout or the like. It can also be provided that the cutout is introduced with at least one expansion. In particular, the cutout can be introduced with two expansions which are preferably formed at the respective end portions of the cutout. The at least one expansion can be provided to accommodate a dowel later.

A further development of the method can moreover provide that the machining tool is arranged at the intermediate position inclined with respect to the narrow surface and the relative movement of the machining tool for milling the cutout is performed at least in part in the inclined arrangement.

The inclination of the machining tool during the milling process can be provided at any angle between 0° and 90° with respect to the narrow surface. By such an inclined alignment of the machining tool with respect to the narrow surface, a variably adjustable milling depth can be achieved. Moreover, due to the inclined arrangement of the machining tool during the milling process, an optimized chip removal can be made possible.

An embodiment of the method can provide that the plate-shaped workpiece is divided by a cutting machining process into at least two partial workpieces, wherein the separating region is formed between the at least two partial workpieces by the cutting machining process.

In this regard, the at least two partial workpieces are introduced in particular by a milling process from the plate-shaped workpiece. Such a method is also designated as nesting method.

In a further development of the method, the machining of the plate-shaped workpiece can be performed by a CNC-controlled machining device or a CNC-controlled machining center and the plate-shaped workpiece can be fixed on a workpiece support during machining.

Thus, additional machining steps can be performed on the plate-shaped workpiece and/or the partial workpieces, for example by an additional milling unit, sawing unit, drilling unit and/or edge machining unit or the like of the CNC-controlled machining device or the CNC-controlled machining center. Thus, it is possible to finish the machining of the partial workpieces while they are clamped.

The object is further solved by a machining device for machining plate-shaped workpieces, having a workpiece support for accommodating at least one plate-shaped workpiece, having a cutting machining unit for introducing at least one separating region into the plate-shaped workpiece, having a milling unit for performing a milling process on at least one narrow surface of the workpiece, and having a setting device for bringing about a relative movement between the workpiece and the cutting machining unit and/or the milling unit. In this regard, it is provided that at least one machining tool of the milling unit can be positioned within the separating region in the plate-shaped workpiece, wherein a method according to one of the above-described embodiments can be performed by the milling unit.

Such a machining device can make machining by milling within a separating region on a narrow surface of the workpiece possible. In this regard, the machining of the workpiece or the partial workpieces can be performed while they are clamped on the workpiece holder such that the plate-shaped workpiece is firstly divided and subsequently the cutout can be introduced into the side surface. In this way, a reduction of the work steps and consequently an efficient machining of the workpiece can be achieved.

A particularly preferred embodiment of the machining device can provide that at least one head portion of the machining unit, which can be inserted into the separating region and where the machining tool is accommodated, has a width of less than 30 mm, preferably less than 16 mm, and/or the machining tool has a length of more than 5 mm and less than 100 mm.

This enables a compact configuration of the machining unit with a comparatively great length of the machining tool in relation to the width of the head portion. In this way, the machining unit can be inserted into very narrow separating regions to introduce the cutout into the narrow surface of the partial workpiece, whereby low material offcuts during machining of the workpiece can be made possible.

### BRIEF DESCRIPTION OF THE DRAWINGS

Further features and advantages of a device, a use and/or a method will be apparent from the following description of embodiments with reference to the accompanying drawings. In these drawings,

FIG. 1 shows a schematic plan view of an exemplary embodiment of a machining device according to the disclosure;

FIG. 2 shows a schematic detailed illustration of the machining device in FIG. 1 in a side view;

FIG. 3 shows a schematic illustration of a first method step of a machining method according to the disclosure;

FIG. 4 shows a schematic illustration of a second method step of the machining method according to the disclosure;

FIG. 5 shows a schematic illustration of a third method step of the machining method according to the disclosure;

FIG. 6 shows a schematic illustration of a first method step of a further machining method according to the disclosure;

FIG. 7 shows a schematic illustration of a second method step of the machining method according to the disclosure;

FIG. 8 shows a schematic illustration of a third method step of the machining method according to the disclosure;

FIG. 9 shows a schematic illustration of a fourth method step of the machining method according to the disclosure;

FIG. 10 shows a schematic illustration of a fifth method step of the machining method according to the disclosure.

### DESCRIPTION OF EMBODIMENTS

Identical reference numbers used in different figures designate identical, corresponding or functionally similar elements.

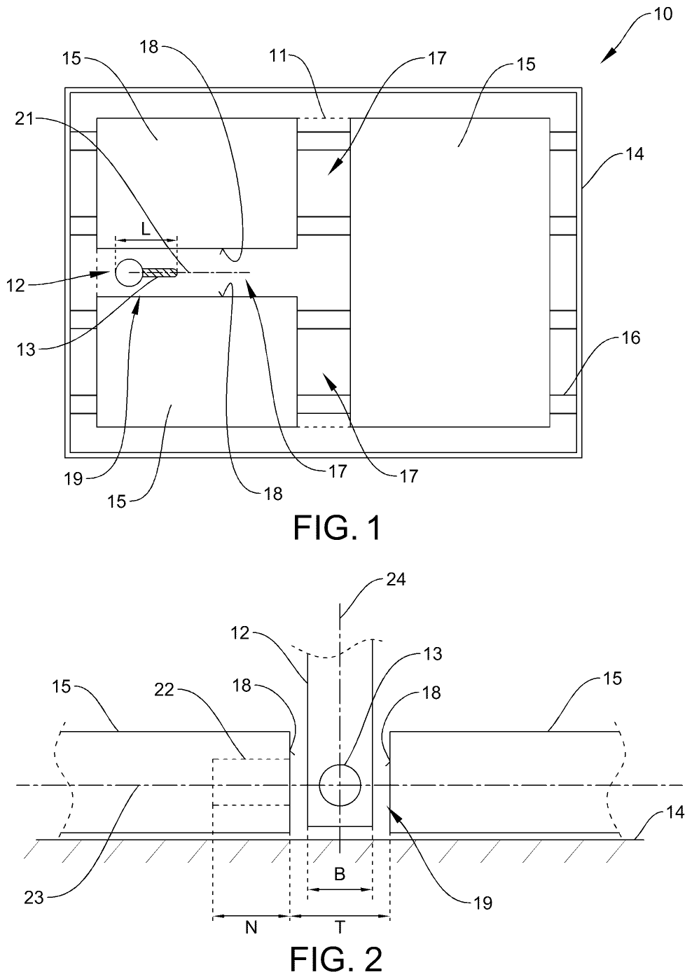

FIG. 1 shows a schematic illustration of an exemplary embodiment of a machining device 10 according to the disclosure for machining a plate-shaped workpiece 11 in a plan view. In FIG. 1, the plate-shaped workpiece 11 is illustrated by the dashed lines and the continuous lines show the partial workpieces 15 formed of the workpiece 11, as will be described in more detail below. In particular, the machining device 10 is configured as a wood-machining device. For machining the workpiece 11, the machining device 10 comprises at least one machining unit 12. In the present embodiment, the machining unit 12 is configured as a milling unit 12, although other machining units can also be used within the scope of the invention. In the present embodiment, it comprises a milling tool 13, in particular an end milling tool. Alternatively or additionally, the machining device 10 can comprise further machining units, for example with a further milling tool, sawing tool, drilling tool, and/or edge machining tool or the like, which are not illustrated in more detail.

The machining unit 12 is provided to be displaceable with respect to the workpiece 11 in an X direction, Y direction and/or Z direction in order to perform a machining process in several spatial directions. The further machining unit is also provided to be displaceable with respect to the workpiece 11 in the X direction, Y direction and/or Z direction for performing a machining process. The machining device 10 is in particular configured as a CNC-controlled machining device or as a CNC-controlled machining center.

As shown in FIG. 1, the machining device 10 is configured as a stationary machining device. Here, the workpiece 11 to be machined is positioned on a workpiece support 14 by a machine operator or by a machine. The workpiece support 14 constitutes a stationary holder for one or a plurality of plate-shaped workpieces 11. The workpiece support 14 is configured, for example, as a console or table. In order to fix the workpiece 11 at a stationary position for the machining process, the workpiece support 14 has a clamping device 16. Said clamping device 16 can, for example, be configured as a vacuum clamping device.

The plate-shaped workpieces 11 are in particular such that are made at least in part of wood, wood materials, plastic, composite material or the like. Such workpieces are used, for example, in the field of furniture and components manufacturing. These can be a wide variety of workpieces, for example solid wood boards or chipboards, lightweight boards, sandwich boards or the like. However, the present invention is not limited to such workpieces.

As illustrated in FIG. 1, the plate-shaped workpiece 11 is divided into a plurality of partial workpieces 15. This is performed by the at least one further machining unit which is also configured in particular as a milling unit or as a sawing unit and is not illustrated in more detail in FIG. 1. The partial workpieces 15 are milled or sawed out of the plate-shaped workpiece 11. The partial workpieces 15 can have the same dimensions as well as different dimensions. To divide the workpiece 11 into the partial workpieces 15, separating regions 17 are introduced into the workpiece 11 by the further machining unit. The separating regions 17 are in particular straight milling paths. After being divided, the partial workpieces 15 can be connected with each other by individual bridges or in another way. The separating regions 17 can also be separating cuts. The separating regions 17 are limited by narrow surfaces 18 of adjacent partial workpieces 15. It is to be noted that, in FIG. 2, a width T of the separating regions 17 is shown disproportionately large in relation to the dimensions of the partial workpieces 15 for illustrative purposes. The width T of the separating regions 17 is a few millimeters, preferably 30 mm or 16 mm. However, the width T of the separating regions 17 is not restricted to said dimensions and can have any width.

For machining a partial workpiece 15, the machining unit 12 is positioned within a separating region 17. The machining unit 12 is inserted into the separating region 17 in such a way that the milling tool 13 of the machining unit 12 is positioned between the narrow surfaces 18 which limit the separating region 17. In this way, the milling tool 13 can mill a cutout, such as a groove 22, for example, into the narrow surface 18 of the partial workpiece 15 in the image plane, i.e. in a horizontal direction, which will be addressed in more detail below. Said cutout 22 can serve e.g. for subsequently inserting connectors, as are common in pieces of furniture, for example.

In FIGS. 1 and 2, the machining unit 12 is arranged at a starting position 19 in the separating region 17. At the starting position 19, the milling tool 13 is aligned with its rotational axis 21 along a longitudinal extension of the separating region 17. The rotational axis 21 can be aligned essentially parallel to the narrow surfaces 18 of the partial workpieces 15. Due to this alignment, a machining unit 12 can be inserted into the separating region 17, which has a greater length L in the direction of the milling tool 13 than the width T of the separating region 17. At least a head width B of the machining unit 12 is smaller than the width T of the separating region 17. Since the separating region 17 has the width T of a few millimeters, the machining unit 12 has an accordingly small installation space in particular in the direction of the width B. At least in a head portion, where the milling tool 13 is arranged, the machining unit 12 has a width B of less than 30 mm, preferably less than 16 mm. A length L of the milling tool is preferably between 5 mm and 100 mm. However, the length of the milling tool is not limited to these lengths. In this way, the machining unit 12 can be inserted into the separating region 17 in a longitudinal direction, i.e. at the starting position 19 illustrated in FIGS. 1 and 2, between the narrow surfaces 18 of the partial workpieces 15, and a groove 22 can be formed which has a greater depth N than the width T of the separating region 17.

In FIG. 2, it is illustrated that the milling tool 13 for introducing the groove 22 into the narrow surface 18 of the partial workpiece 15 is arranged in a pivoting plane 23. The pivoting plane 23 is arranged within the partial workpiece 15. The pivoting plane 23 is aligned in particular parallel to a workpiece plane of the partial workpiece 15. As a result of a pivoting movement of the machining unit 12 about a pivot axis 24, the milling tool 13 performs a pivoting movement in the direction of the narrow surface 18 of the partial workpiece 15. As a result of a simultaneous rotation of the milling tool 13 about its rotational axis 21, the groove 22 is thus milled into the narrow surface 18 of the partial workpiece 15, as will be described in more detail with regard to the following figures. The pivot axis 24 is aligned in particular orthogonally to the pivoting plane 23 or the workpiece plane.

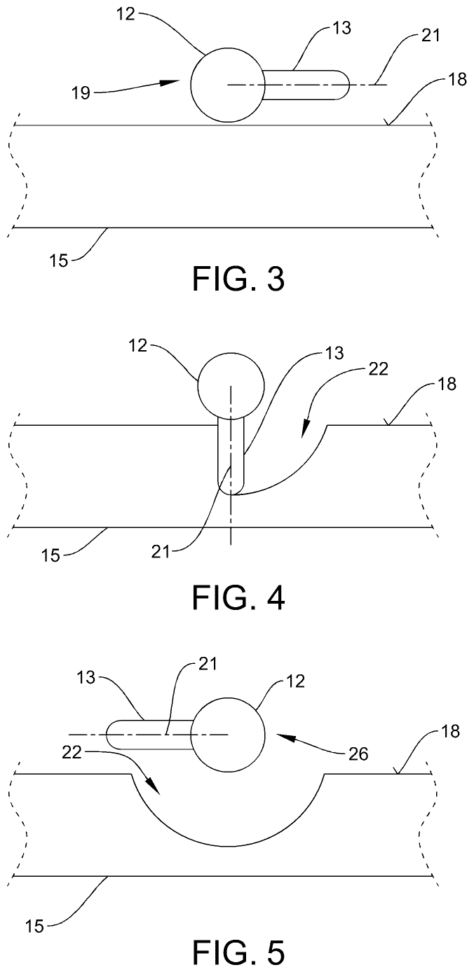

In FIGS. 3 to 5, method steps for milling an exemplary groove 22 into the narrow surface 18 of the partial workpiece 15 are shown. FIGS. 3 to 5 are sectional views of the machining unit 12 as well as one of the partial workpieces 15, wherein the section lies in the pivoting plane 23 illustrated in FIG. 2.

By means of these method steps, a partially circular groove 22 can be milled into the narrow surface 18 of the partial workpiece 15. In this regard, it is to be noted that the milling tool 13 preferably has a round milling tip for forming said partially circular groove 22. The milling tool 13 can also have a flat milling tip. According to FIG. 3, the machining unit 12 is firstly arranged at the starting position 19 already described. From said starting position 19, the machining unit 12 performs the pivoting movement about the pivot axis 24 such that the milling tool 13 is pivoted in the pivoting plane 23 in the direction of the narrow surface 18 of the partial workpiece 15. As a result of the simultaneous rotation of the milling tool 13 about the rotational axis 21, the groove 22 is milled into the narrow surface 18. FIG. 4 illustrates an intermediate step of said milling process.

During the pivoting movement, it can be provided that the milling tool 13 simultaneously performs a relative movement along the narrow surface 18. The relative movement and the pivoting movement can be superimposed. It can also be provided that the pivoting movement is interrupted for performing said relative movement. In this way, a length of the groove 22 can be individually adjusted.

In FIG. 5, the machining unit 12 is shown at an end position 26 after performing the pivoting movement, wherein the partially circular groove 22 has been formed completely by the milling process. It can also be provided that the machining unit 12 is pivoted back into the starting position 19 after milling of the partially circular groove 22. By a displacement of the machining unit 12 with respect to the partial workpiece 15, a plurality of grooves 22 can be milled into the narrow surfaces 18 of the partial workpiece 15.

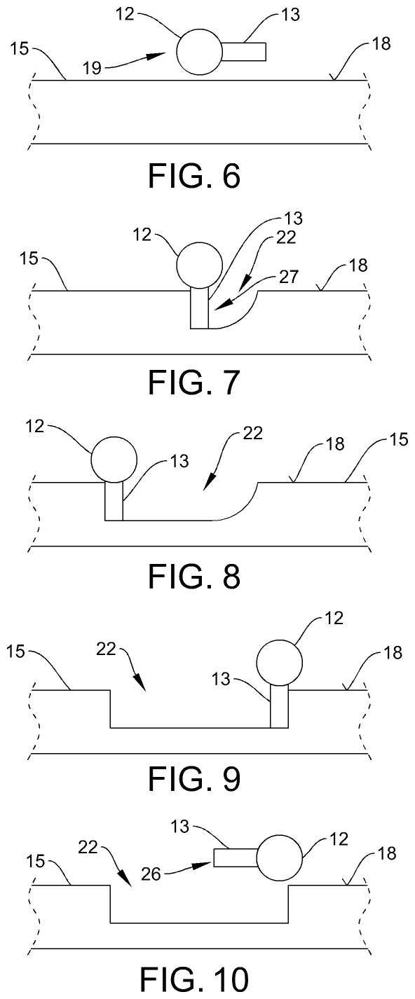

In FIGS. 6 to 10, method steps for milling an alternative exemplary groove 22 into the narrow surface 18 of the partial workpiece 15 are shown. FIGS. 6 to 10 are sectional views of the machining unit 12 as well as one of the partial workpieces 15, wherein the section lies in the pivoting plane 23 illustrated in FIG. 2.

By means of these method steps, a groove 22 that is rectangular in the longitudinal section can be milled into the narrow surface 18 of the partial workpiece 15. In this regard, it is to be noted that the milling tool 13 preferably has a flat milling tip for forming said rectangular groove 22. According to FIG. 3, the machining unit 12 is firstly arranged at the starting position 19. From said starting position 19, the machining unit 12 performs the pivoting movement about the pivot axis 24 such that the milling tool 13 is pivoted in the pivoting plane 23 in the direction of the narrow surface 18 of the partial workpiece 15. As a result of the simultaneous rotation of the milling tool 13 about the rotational axis 21, the groove 22 is milled into the narrow surface 18. From the starting position 19, the machining unit 12 is firstly pivoted into an intermediate position 27 which is illustrated in FIG. 7. At said intermediate position 27, the rotational axis 21 of the milling tool 13 is aligned orthogonally to the narrow surface 18 of the partial workpiece 15. This means that the milling tool 13 is arranged perpendicularly to the narrow surface 18. In this way, a partially circular groove 22 is firstly milled into the narrow surface 18.

Alternatively, it can also be provided that the milling tool 13 is arranged at the intermediate position 27 inclined with respect to the narrow surface 18 and the subsequent relative movement of the milling tool 13 for milling the groove 22 is performed in said inclined arrangement. In this regard, the angle of inclination can be provided between 0° and 90° with respect to the narrow surface 18.

From the intermediate position 27, a displacement of the machining unit 12 is performed parallel to the narrow surface 18, as shown in FIG. 8. Subsequently, a displacement of the machining unit 12 is performed in the opposite direction parallel to the narrow surface 18, as illustrated in FIG. 9. In this way, the rectangular groove 22 is milled into the narrow surface 18 of the partial workpiece 15, wherein a length of the groove 22 can be variably adjusted depending on the length of the displacement of the machining unit 12. The directions of the displacements can also be reversed.

For forming the groove 22, the machining unit 12 can also be moved in two or three spatial directions with respect to the narrow surface 18 during the milling process. By moving back and forth in the spatial directions several times, the groove 22 can be milled in this way with any length and/or any width and/or any depth. An individual shape of the groove 22 can thus also be formed. For example, the groove 22 can be milled with at least one expansion, in particular two expansions. This expansion/These expansions can be provided to accommodate one or more dowels later.

In FIG. 10, the machining unit 12 is illustrated as pivoted into the end position 26 after milling the groove 22. It can also be provided that the machining unit 12 is moved back into the starting position 19 after forming the groove 22.

1. Method for machining plate-shaped workpieces, which are preferably made at least in part of wood, wood material, plastic, composite material or the like, by a machining device, the method comprising:
positioning a plate-shaped workpiece on a workpiece support,
introducing at least one separating region into the plate-shaped workpiece,
positioning a machining tool, in particular a milling tool, within the at least one separating region,
performing a pivoting movement of the machining tool in the direction of at least one narrow surface of the plate-shaped workpiece, which is adjacent to the at least one separating region, wherein,
as a result of the pivoting movement of the machining tool, a cutout is introduced, in particular milled, into the at least one narrow surface of the plate-shaped workpiece.

2. Method according to claim 1, in which the machining tool is further positioned in the separating region at a starting position in which a rotational axis of the machining tool is aligned essentially in the direction of a longitudinal extension of the separating region.

3. Method according to claim 1, in which the pivoting movement of the machining tool for introducing the cutout is further performed in a pivoting plane which lies within the workpiece, preferably aligned parallel to a workpiece plane of the workpiece.

4. Method according to claim 1, in which the pivoting movement of the machining tool is further performed about a pivot axis which is preferably aligned orthogonally to the workpiece plane of the workpiece.

5. Method according to claim 1, in which, as a result of the pivoting movement of the machining tool, a partially circular cutout is further introduced into the narrow surface of the workpiece and, after the introduction of the cutout, the machining tool is pivoted into an end position in the separating region or is pivoted back into the starting position.

6. Method according to claim 1, in which, during the pivoting movement of the machining tool, a relative movement between the machining tool and the workpiece is further performed along the narrow surface or the pivoting movement is interrupted for performing the relative movement.

7. Method according to claim 1, in which the machining tool is further pivoted, after positioning within the at least one separating region, into an intermediate position, whereby a partial cutout is introduced into the narrow surface, and a relative movement in at least one spatial direction is brought about between the machining tool and the workpiece in order to form a cutout with an individual shape.

8. Method according to claim 1, in which the machining tool is further arranged at the intermediate position inclined with respect to the narrow surface and the relative movement of the machining tool for introducing the cutout is performed at least in part in the inclined arrangement.

9. Method according to claim 1, in which the plate-shaped workpiece is further divided by a cutting machining process into at least two partial workpieces, wherein the separating region is formed between the at least two partial workpieces by the cutting machining process.

10. Method according to claim 1, in which the machining of the plate-shaped workpiece is further performed by a CNC-controlled machining device or a CNC-controlled machining center and the plate-shaped workpiece is fixed on a workpiece support during machining.

11. Machining device for machining plate-shaped workpieces, which are preferably made at least in part of wood, wood material, plastic, composite material or the like, having a workpiece support for accommodating at least one plate-shaped workpiece, having a cutting machining unit for introducing at least one separating region into the plate-shaped workpiece, having a machining unit for performing a machining process on at least one narrow surface of the workpiece, and having a setting device for bringing about a relative movement between the workpiece and the cutting machining unit and/or the machining unit, characterized in that at least one machining tool, in particular milling tool, of the machining unit can be positioned within the separating region in the plate-shaped workpiece, whereby a method according to claim 1 can be performed by the machining unit.

12. Machining device according to claim 11, in which at least one head portion of the machining unit, which can be inserted into the separating region and where the machining tool is accommodated, has a width (B) of less than 30 mm, preferably less than 16 mm, and/or the milling tool has a length (L) of more than 5 mm and less than 100 mm.
